(19) United States
(12) Patent Application Publication
(10) Pub. No.: US 2016/0379210 A1
(43) Pub. Date: Dec. 29, 2016

(54) METHOD OF CONDUCTING A TRANSACTION BASED ON A CODE

(71) Applicant: MasterCard Asia/Pacific Pte. Ltd., Singapore (SG)

(72) Inventor: Anshul PANDEY, Gurgaon (IN)

(21) Appl. No.: 15/189,805

(22) Filed: Jun. 22, 2016

(30) Foreign Application Priority Data
Jun. 29, 2015 (SG) 10201505174Q

(51) Int. Cl. G06Q 20/38; G06Q 20/40

(52) U.S. Cl. CPC G06Q 20/385; G06Q 20/405; G06Q 20/4012

(57) ABSTRACT

A method of conducting a transaction. The method receives a first request from an originating device. The first request comprises a first identification. A code is provided to a payer device for conducting the transaction. A second request is processed from a payee device to complete the transaction. The second request comprises a transaction amount, wherein the transaction is completed based on a verification of the code.

### RELATED APPLICATIONS

The present application claims priority to Singapore Patent Application No. 10201505174Q, entitled A METHOD FOR CONDUCTING A TRANSACTION BASED ON A CODE, filed Jun. 29, 2015 and is hereby incorporated by reference in its entirety.

### FIELD OF THE DISCLOSURE

The present disclosure relates to a method of conducting a transaction based on a code.

### BACKGROUND

A transaction can be made in many forms. The most common form is cash transaction. However, in many countries, cashless transaction has become increasingly common. In a cashless transaction, credit or debit card are typically used for electronic payment, instead of cash.

These current transaction mechanisms present a number of challenges, especially in developing countries. For example, cash or cards transactions can only be carried out if the payers have the cash or cards in hand. Even for an online purchase where the payers use a card to make a payment, the details of the cards would have to be provided to the merchant. In the case of a debit card, the payer can only make a transaction which has a lower amount than the bank account associated with the debit card used.

As many of the transactions do not require any identification proof from the payer, it also means that anyone who obtains the cash or cards would be able to make payment, whether authorized or not.

In addition to cards, mobile devices are also used to make cashless transactions. A mobile device is usually linked to at least one bank account. This can be tedious for some transactions as a mobile number is required from both the payer and payee.

### SUMMARY

According to a first aspect of the present disclosure, there is provided a method for conducting a transaction, the method comprising:

receiving a first request from an originating device, the first request comprises a first identification;

providing a code to a payer device for conducting the transaction; and

processing a second request from a payee device to complete the transaction, the second request comprises a transaction amount,

wherein the transaction is completed based on a verification of the code.

The second request may further comprise the code.

The first request may further comprise a selected amount.

The method may further comprise:

verifying the selected amount;

authorizing a generation of the code based on a comparison between the selected amount and a fund limit of an account associated with the payer.

The first identification may comprise one or more of: a phone number, a biometric data, a predetermined answer to a query, a PIN code and a password.

The method may further comprise:

verifying the first identification; and

authorizing the generation of the code based on the verification of first identification.

The method may further comprise:

receiving a second identification from the payee device; and

authorizing the transaction based on the second identification.

The second identification may comprise one or more of: a phone number, a biometric data, a predetermined answer to a query, a PIN code and a password.

The method may further comprise authorizing the transaction based on a time duration associated with the code.

The method may further comprise authorizing the transaction based on a difference between the selected amount and a sum of each transaction amount authorized using the code and the transaction amount in the second request.

The originating device and the payer device may comprise a mobile device.

The method may further comprise sending a notification to the second device, wherein the notification comprises an outcome of the process of the second request.

The method may further comprise processing an instruction to credit the transaction amount from the account associated with the payer.

According to a second aspect of the present disclosure, there is provided a server for conducting a transaction, the server comprising:

at least one processor; and

at least one memory including computer program code;

the at least one memory and the computer program code configured to, with the at least one processor, cause the server at least to:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.

The server may be further caused to:

verifying the first identification; and

authorizing the generation of the code based on the verification of first identification.

The server may be further caused to:

receiving a second identification from the payee device; and

authorizing the transaction based on the second identification.

The server may be further caused to authorizing the transaction based on a time duration associated with the code.

The server may be further caused to authorizing the transaction based on a difference between the selected amount and a sum of each transaction amount authorized using the code and the transaction amount in the second request.

According to a third aspect of the present disclosure, there is provided a computer storage medium having stored thereon computer code means to instruct a computing device to execute a method for conducting a transaction, the method comprising:

receiving a first request from an originating device, the first request comprises a first identification;

providing a code to a payer device for conducting the transaction; and

processing a second request from a payee device to complete the transaction, the second request comprises a transaction amount,

wherein the transaction is completed based on a verification of the code.

According to a fourth aspect of the present disclosure, there is provided a system for conducting a transaction comprising:

an originating device for sending a first request;

a payer device for receiving a code;

a payee device for sending a second request; and

a payment server, the payment server is configured to:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.

### BRIEF DESCRIPTION OF THE DRAWINGS

Embodiments of the disclosure will be better understood and readily apparent to one of ordinary skill in the art from the following written description, by way of example only, and in conjunction with the drawings, in which:

FIG. 1 shows a flow chart illustrating a method for conducting a transaction according to an example embodiment.

FIG. 2 shows a system for conducting a transaction according to an example embodiment.

FIG. 3 shows an exemplary wireless computing device suitable for use in the example embodiment.

FIG. 4 shows an exemplary computing device suitable for use in the example embodiment.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence leading to a desired result. The sequence are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method may be appropriate. The structure of a computer will appear from the description below.

In addition, the present specification also implicitly discloses a computer program, in that it would be apparent to the person skilled in the art that the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the method.

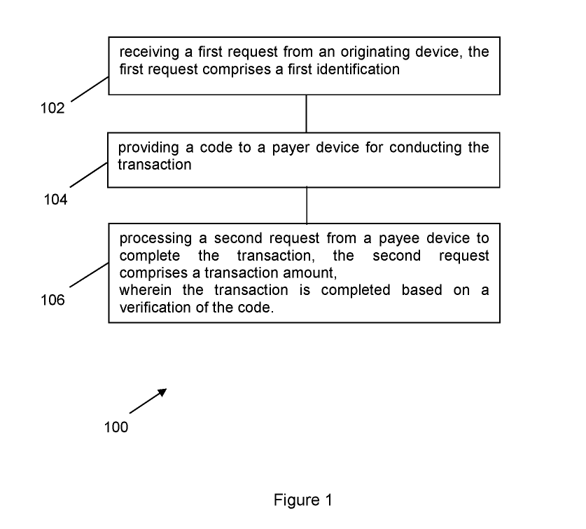

FIG. 1 shows a flow chart 100 illustrating a method for conducting a transaction according to an example embodiment. At block 102, a first request is received from an originating device. The request comprises a first identification. At block 104, a code is provided to a payer device for conducting the transaction. At block 106, a second request from a payee device to complete the transaction is processed. The second request comprises a transaction amount. The transaction is completed based on a verification of the code.

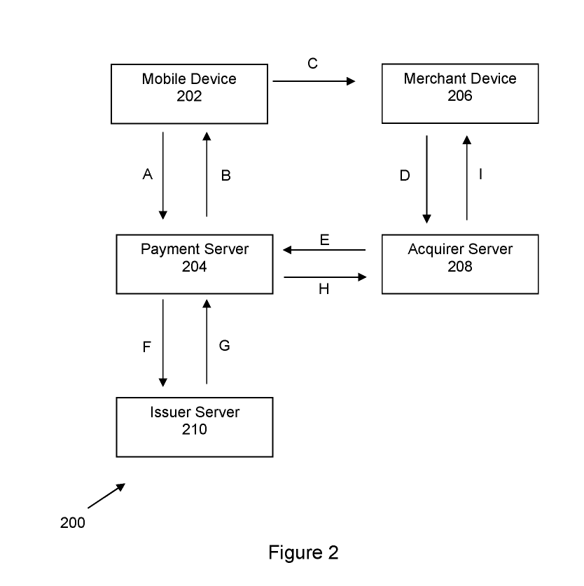

FIG. 2 shows a system 200 for conducting a transaction according to an example embodiment. Here, the transaction refers to an electronic payment transaction involving a payer, a payment facilitator, a payee, an acquiring entity and an issuing entity. In the embodiment, the system 200 comprises a mobile device 202, a payment server 204, a merchant device 206, an acquirer server 208 and an issuer server 210.

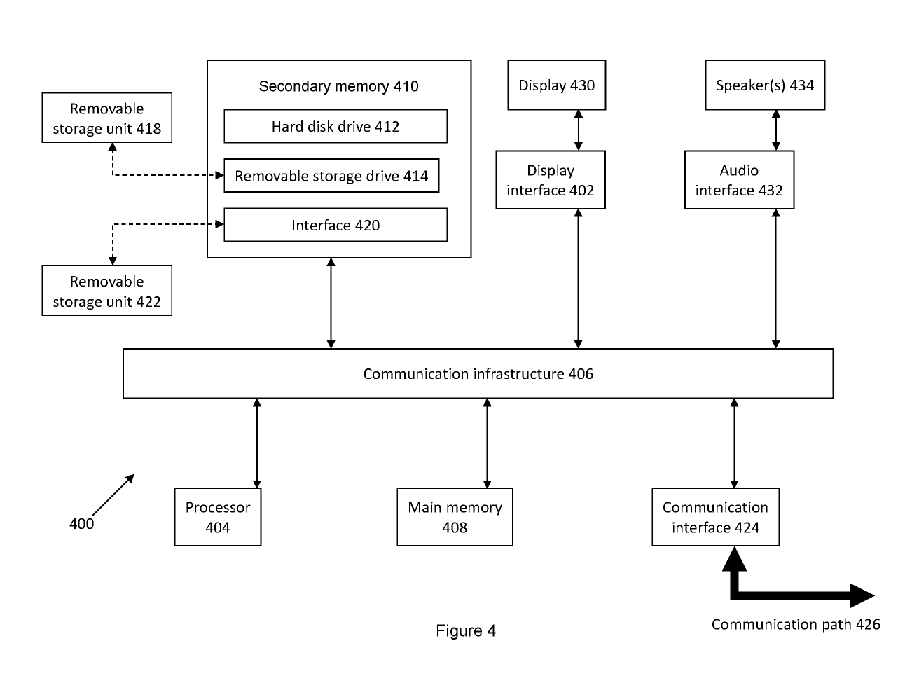

Use of the term “server” herein may be understood to mean a single computing device or a plurality of interconnected computing devices which operate together to perform a particular function. That is, the server may be contained within a single hardware unit or be distributed among several different hardware units. An exemplary computing device which may be operated as a server is described below with reference to FIG. 4.

In the embodiment, the transaction involves two parties, i.e. payer and payee. The originating device, represented in FIG. 2 as mobile device 202 is associated with the payer. At step A, the mobile device 202 sends out a first request for a code to the payment server 204. The payment server 204 is associated with the payment facilitator, who facilitates the processing of transactions, such as clearing and settling funds for payments between two or more entities (e.g. two banks). The first request comprises a first identification, which may comprise one or more of: a phone number, biometric data, a predetermined answer to a query, a PIN code or a password.

For example, in an embodiment, the payer requests for a code from the payment server 204 using a mobile application in the mobile device 202. When sending the first request, the payer may also provide other details such as a biometric data, a predetermined answer to a query, a PIN code or a password to the payment server 204 such that the identity of the payer may be verified by the payment server 204. In other embodiments, the payment server 204 may, upon receiving the first request from the mobile device 202, request the payer to provide the first identification.

The payer may also enter a selected amount when sending the first request to the payment server 204. In other embodiments, the payment server 204 may, upon receiving the first request from the mobile device 202, requests the payer to enter the selected amount. The selected amount is the limit of transaction allowable using the code that is provided to the payer.

It will be appreciated that the originating device involved at step A may be devices such as a personal computer, a land-line telephone, or any type of mobile devices such as a mobile phone, a laptop computer, a tablet computer and the like. The first request may also be made in the form of a telephone call, text/instant messaging, voice over internet protocol (VoIP) and etc. For example, a payer may call the payment server 204 using a land-line phone. The payer may subsequently provide one or more first identification or the selected amount via an interactive voice response (IVR).

The generation of the code may be subjected to various verifications of the payment server 204, as discussed in embodiments below. The payment server 204 may be configured to verify the first identification received from the mobile device 202 and to authorize the generation of the code based on the verification of the first identification. In particular, the payment server 204 may authorize the generation of the code if the first identification received is a correct identification of the payer.

The payment server 204 may also be configured to verify the selected amount received from the mobile device 202 and to authorize the generation of the code based on the comparison between the selected amount and a fund limit of an account associated with the payer. In particular, the payment server 204 may authorize the generation of the code if the selected amount is lower than the fund limit.

At step B, the code generated is provided to the payer device, represented in FIG. 2 as mobile device 202 for conducting the transaction. For example, the code may be sent as a Quick Response (QR) Code via a mobile application of the mobile device 202. In other embodiments, the code may be sent to the mobile device 202 in different forms, e.g. text/instant message, voice message, interactive voice response (IVR), verbal communication and etc.

As can be seen in FIG. 2, in this embodiment, the originating device, which sends the first request, and the payer device, which receives the code are the same device, i.e. mobile device 202. In other embodiments, the originating device and payer device may be different devices. For example, the payer may make a phone call from a land-line requesting for the code and also providing a mobile device number to the server. The code may subsequently be sent to the mobile device.

At step C, after receiving the code, the payer who wishes to purchase a good or service provides the code to the payee when making a payment.

The payee uses a payee device, represented as the merchant device 206 in FIG. 2 to conduct the transaction. The merchant device 206 may be a point-of-sale (POS) terminal, a personal computer, a computer server (hosting a website, for example), a land-line telephone, or any type of mobile device such as a mobile phone, a laptop computer, a tablet computer and the like. In an embodiment, the payer may be requested to enter a second identification into the merchant device 206. The second identification may comprise one or more of: a phone number, a biometric data, a predetermined answer to a query, a PIN code and a password.

At step D, the merchant device 206 sends a second request to an acquirer server 208. The acquirer server 208 is associated with the acquiring entity which issues (e.g. establishes, manages, administers) an account of the merchant. Examples of the acquiring entity include a bank and/or other financial institution. The second request comprises the transaction amount.

The merchant device 206 may also send the second identification, if any, provided by the payer to the acquirer sever 208.

At step E, the acquirer server 208 sends the information received from the merchant device 206 to the payment server 204. Upon receiving the information from the acquirer server 208, the payment server 204 processes the second request based on a verification of the code. In particular, the payment server 204 may approve the transaction if the code received by the payment server 204 at step E is identical to the code provided by the payment server 204 to the mobile device 202 at step B. The authorization of the transaction may also be subjected to other verifications, as discussed in embodiments below.

In an embodiment, the payment server 204 may also request the second identification from the merchant device 206. The payment server 204 may be configured to authorize the transaction based on the second identification. In particular, the payment server 204 may authorize the transaction only if the second identification received is a correct identification.

In addition, the code provided by the payment server 204 in step B may only be valid for a limited time duration. In an embodiment, the payment server 204 may authorize the transaction based on a validity of the code. For example, a time of providing the code (at step B) and a time of receiving the code from the second request (at step E) are determined by the payment server 204 and the validity of the code is determined by the payment server 204. The transaction would only be approved by the payment server if the code received is a valid code. In an embodiment, a payer may make multiple transactions within the duration where the code is still valid. However, in other embodiments, the code may only be valid for a single transaction within the duration.

In a further embodiment, the payment server 204 may receive the selected amount from the originating device in step A. The payment server 204 may authorize the transaction based on a difference between the selected amount and a sum of each transaction amount authorized using the code and the transaction amount in the second request. The transaction is only approved if the sum is lower than the selected amount. If only one transaction is allowed using the code, the payment server 204 may authorize the transaction based on a difference between the selected amount and the transaction amount. In particular, the transaction is only approved if the transaction amount is lower than the selected amount.

In yet a further embodiment, the payment server may also authorize the transaction based on the fund limit of the account associated with the payer. If the transaction amount or the sum of transaction amounts as explained above is higher than the fund limit, the transaction may be rejected.

At step F, the payment server 204 sends the information regarding the second request to the issuer server 210. The issuer server 210 is associated with the issuing entity which issues (e.g. establishes, manages, administers) an account (e.g. a financial bank account) of the payer. The issuer server 210 may be configured to perform several checks before authorizing the transaction. For example, in the case of a credit card account, the issuer server 210 may check on availability of credit in the credit card account associated with the payer.

At step G, the issuer server 210 sends an outcome of the checks to the payment server 204. At step H, the payment server 204 sends a notification to the acquirer server 208, approving or rejecting the second request. At step I, the acquiring server 208 in turn sends the notification to the merchant device 206. The payer may subsequently receive the goods or service, if the transaction is approved.

In an embodiment, the merchant device 206 may send the second request to the payment server 204 for an authorization of the transaction, instead of sending it to acquirer server 208. After authorizing the transaction, the payment server 204 may send the information regarding the second request to the acquirer server 208. The acquirer server 208 may subsequently send the second request directly to the issuer server 210 to authorize the transaction, without passing through the payment server 204. The issuer server 210 may also send the outcome of the checks done to the acquirer server 208, without passing through the payment server 204.

It should be noted that the payment server 204 may also be configured to process an instruction to credit the transaction amount from the account associated with the payer. For example, in the case of a credit card account, after transactions are approved, the payment server 204 distributes the transaction to the issuer server 210. The issuer bank would deduct the transaction amount from the credit card account associated with the payer.

Embodiments of the present disclosure provide a method for conducting a transaction, in which the payer may request for a code when a transaction has to be made. The code is subsequently provided by the payer to the merchant as a system of payment. As a result, the payer may make a transaction without using cash or card. The method also provide the user a safe way of handling money. The method may be advantageous, especially in emerging market economy where only cash is accepted and the infrastructure for credit card payment is scarce. The method for conducting a transaction as explained above may provide the merchant and consumer an alternative method to make a transaction.

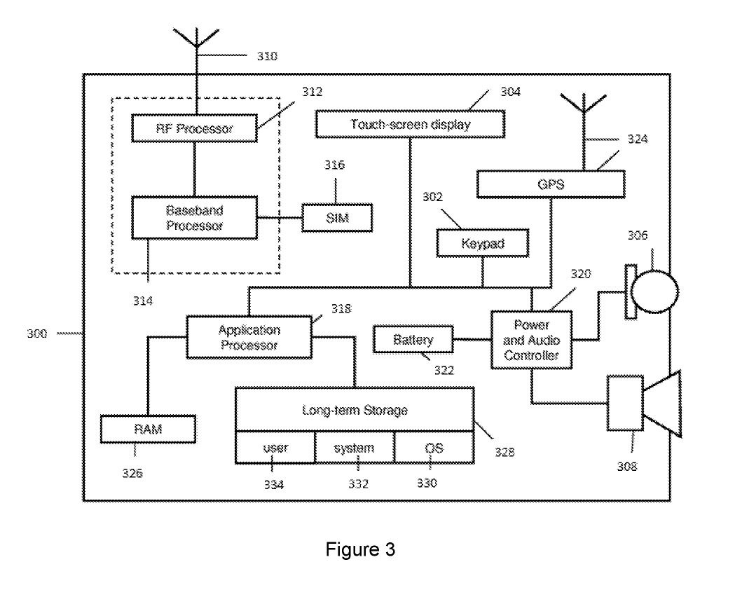

FIG. 3 shows an exemplary wireless computing device 300 that may be utilized to implement the originating and payer devices (such as 202 in FIG. 2) and/or the payee device (such as 206 in FIG. 2).

The wireless device 300 comprises a keypad 302, a touch-screen 304, a microphone 306, a speaker 308 and an antenna 310. The wireless device 300 is capable of being operated by a user to perform a variety of different functions, such as, for example, hosting a telephone call, sending an SMS message, browsing the Internet, sending an email and providing satellite navigation.

The wireless device 300 comprises hardware to perform communication functions (e.g. telephony, data communication), together with an application processor and corresponding support hardware to enable the wireless device 300 to have other functions, such as, messaging, Internet browsing, email functions and the like. The communication hardware is represented by a radio frequency (RF) processor 312 which provides an RF signal to the antenna 310 for the transmission of data signals, and the receipt therefrom. Additionally provided is a baseband processor 314, which provides signals to and receives signals from the RF Processor 312. The baseband processor 314 also interacts with a subscriber identity module (SIM) 316, as is well known in the art. The communication subsystem enables the wireless device 300 to communicate via a number of different communication protocols including 3G, 4G, GSM, WiFi, Bluetooth™ and/or CDMA. The communication subsystem of the wireless device 300 is beyond the scope of the present disclosure.

The keypad 302 and the touch-screen 304 are controlled by an application processor 318. A power and audio controller 320 is provided to supply power from a battery 322 to the communication subsystem, the application processor 318, and the other hardware. The power and audio controller 320 also controls input from the microphone 306, and audio output via the speaker 308. Also provided is a global positioning system (GPS) antenna and associated receiver element 324 which is controlled by the application processor 318 and is capable of receiving a GPS signal for use with a satellite navigation functionality of the wireless device 300.

In order for the application processor 318 to operate, various different types of memory are provided. Firstly, the wireless device 300 includes Random Access Memory (RAM) 326 connected to the application processor 318 into which data and program code can be written and read from at will. Code placed anywhere in RAM 326 can be executed by the application processor 318 from the RAM 326. RAM 326 represents a volatile memory of the wireless device 300.

Secondly, the wireless device 300 is provided with a long-term storage 328 connected to the application processor 318. The long-term storage 328 comprises three partitions, an operating system (OS) partition 330, a system partition 332 and a user partition 334. The long-term storage 328 represents a non-volatile memory of the wireless device 300.

In the present example, the OS partition 330 contains the firmware of the wireless device 300 which includes an operating system. Other computer programs may also be stored on the long-term storage 328, such as application programs (also referred to as apps), and the like. In particular, application programs which are mandatory to the wireless device 300, such as, in the case of a smartphone, communications applications and the like are typically stored in the system partition 332. The application programs stored on the system partition 332 would typically be those which are bundled with the wireless device 300 by the device manufacturer when the wireless device 300 is first sold.

Application programs which are added to the wireless device 300 by the user would usually be stored in the user partition 334.

As stated, the representation of FIG. 3 is schematic. In practice, the various functional components illustrated may be substituted into one and the same component. For example, the long-term storage 328 may comprise NAND flash, NOR flash, a hard disk drive or a combination of these.

FIG. 4 depicts an exemplary computing device 400, hereinafter interchangeably referred to as a computer system 400, where one or more such computing devices 400 may be used for the payment server 204, payee device 206, acquirer server 208 and issuer server 210. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a hard disk drive 412 and/or a removable storage drive 414, which may include a floppy disk drive, a magnetic tape drive, an optical disk drive, or the like. The removable storage drive 414 reads from and/or writes to a removable storage unit 418 in a well-known manner. The removable storage unit 418 may include a floppy disk, magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In other embodiments, the secondary memory 410 may additionally or alternatively include other similar means for allowing computer programs or other instructions to be loaded into the computing device 400. Such means can include, for example, a removable storage unit 422 and an interface 420.

Examples of a removable storage unit 422 and interface 420 include a program cartridge and cartridge interface (such as that found in video game console devices), a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the disclosure, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port, an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 may further include a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

1. A method for conducting a transaction, the method comprising:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.

2. The method as claimed in claim 1, wherein the second request further comprises the code.

3. The method as claimed in claim 2, wherein the first request further comprises a selected amount.

4. The method as claimed in claim 3, further comprising:
verifying the selected amount;
authorizing a generation of the code based on a comparison between the selected amount and a fund limit of an account associated with the payer.

5. The method as claimed in claim 4, wherein the first identification comprises one or more of: a phone number, a biometric data, a predetermined answer to a query, a PIN code and a password.

6. The method as claimed in claim 5, further comprising:
verifying the first identification; and
authorizing the generation of the code based on the verification of first identification.

7. The method as claimed in claim 6, further comprising:
receiving a second identification from the payee device; and
authorizing the transaction based on the second identification.

8. The method as claimed in claim 7, wherein the second identification comprises one or more of: a phone number, a biometric data, a predetermined answer to a query, a PIN code and a password.

9. The method as claimed in claim 8, further comprising authorizing the transaction based on a time duration associated with the code.

10. The method as claimed in claim 9, further comprising authorizing the transaction based on a difference between the selected amount and a sum of each transaction amount authorized using the code and the transaction amount in the second request.

11. The method as claimed in claim 10, wherein the originating device and the payer device comprise a mobile device.

12. The method as claimed in claim 11, further comprising sending a notification to the second device, wherein the notification comprises an outcome of the process of the second request.

13. The method as claimed in claim 12, further comprising processing an instruction to credit the transaction amount from the account associated with the payer.

14. A server for conducting a transaction, the server comprising:
at least one processor; and
at least one memory including computer program code;
the at least one memory and the computer program code configured to, with the at least one processor, cause the server at least to:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.

15. The server as claimed in claim 14, wherein the server is further caused to:
verifying the first identification; and
authorizing the generation of the code based on the verification of first identification.

16. The server as claimed in claim 15, wherein the server is further caused to:
receiving a second identification from the payee device; and
authorizing the transaction based on the second identification.

17. The server as claimed in claim 16, wherein the server is further caused to authorizing the transaction based on a time duration associated with the code.

18. The server as claimed in claim 17, wherein the server is further caused to authorizing the transaction based on a difference between the selected amount and a sum of each transaction amount authorized using the code and the transaction amount in the second request.

19. A computer storage medium having stored thereon computer code means to instruct a computing device to execute a method for conducting a transaction, the method comprising:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.

20. A system for conducting a transaction comprising:
an originating device for sending a first request;
a payer device for receiving a code;
a payee device for sending a second request; and
a payment server, the payment server is configured to:
receiving a first request from an originating device, the first request comprises a first identification;
providing a code to a payer device for conducting the transaction; and
processing a second request from a payee device to complete the transaction, the second request comprises a transaction amount,
wherein the transaction is completed based on a verification of the code.
